(19) United States
(12) Patent Application Publication
(10) Pub. No.: US 2011/0054884 A1
(43) Pub. Date: Mar. 3, 2011

(54) SYSTEM FOR ASSISTING IN DRAFTING APPLICATIONS

(75) Inventors: Alexander Drakwall, Solna (SE); Daniel Nilsson Broberg, Solna (SE)

(73) Assignee: CAPFINDER AKTIEBOLAG, Hagersten (SE)

(21) Appl. No.: 12/677,136

(22) PCT Filed: Sep. 8, 2008
(86) PCT No.: PCT/SE08/51000

§ 371 Date: Nov. 12, 2010

Related U.S. Application Data
(60) Provisional application No. 60/972,866, filed on Sep. 17, 2007.

(30) Foreign Application Priority Data
Sep. 17, 2007 (SE) 0702079-5

(51) Int. Cl. G06F 17/27

(52) U.S. Cl. 704/9

(57) ABSTRACT

This invention relates to a Method and System for assisting in drafting applications comprising a server (1), with a processing device (2), a memory device (3) either directly or indirectly connected to said server (1) and software (4) installed on said server (1), wherein said memory device (3) includes information regarding requirements to be met by said application (7) and said software (4) is arranged to assist in retrieving relevant information and actively assisting in drafting in said application (7) to meet certain requirements (5), wherein further said memory device (3) contains linguistic information (6) based on data from at least successfully prosecuted applications (7) and that said software (3) is arranged to assist in choosing a linguistic approach based on said linguistic information (6).

### TECHNICAL FIELD

The invention relates to a system for assisting in drafting applications comprising a server, with a processing device, a memory device either directly or indirectly connected to said server and software installed on said server, wherein said memory device includes information regarding requirements to be met by said application and said software is arranged to assist in retrieving relevant information and actively assisting in drafting of said application to meet certain requirements.

### BACKGROUND

A significant part of economy that relates to development, new businesses, growth of a company, research and risky projects often endure public support. The amount of money for this exceeds 200 million euros per annum within the European Union and North America, and therefore has a considerable influence on development/growth in a global perspective. It has been shown that the language used in the application form and the way it has to be adjusted for the evaluating organisations customs, structure and argumentation has a large proportion of influence regarding the financial possibilities. Experience indicate that the linguistics influence is bigger than factual parameters, e.g. the likelihood of the projects potential winnings (human academic or economical). Accordingly the allocation of public support is not performed in an optimized manner from a view point of society.

The languages exaggerated role in the application is probably inevitable. The reasons behind are based upon human psychology and cognition, i.e. different linguistic approaches receive different perceptions among evaluators (group or single individual) e.g.:
1. Considerable differences may exist concerning values of different evaluators, e.g. dominated by tradition etc.
2. Some evaluators should be addressed with an adequate but relatively simple language, not to technical and not to banal, to be successful.
3. Some evaluators reject applications that have not been well presented, not nicely formatted. Often a well structured and well defined application is associated with a well organised project.
4. Some evaluators may not fully understand the intentions of complex projects. In these types of cases it is possible for the project to be misunderstood which often results in finances not being granted and the failure of a project.
5. A formally correctly drafted application may bring with it a sense of “relief and joy” that affects the judgement of evaluators.
6. Each group of assembled people have preferences, often different to one another, how a project should be written, what should be highlighted, what less emphasize should be placed upon etc. One established example is written articles and different preferences amongst Swedish schools, also the differences between different institutions within the respective schools.

Studies within the European Union regarding requests/applications for subsidies reveal that organisations are in need of help regarding the writing of applications and that there are 3 different perspectives;
1. What organizations believe the weaknesses are—organizations with little or no previous experience regarding the subsidy process?
2. Which organizations we experienced as being hard—organizations with a medium amount of experience.
3. Which evaluator assessments have shown themselves to be the hardest regarding applications, the evaluators and afterwards the approved discarded. People with a large amount of experience within the reference majority.

In order of precedence for weaknesses according to the investigation (all in all).
1. Not been familiar to all the possibilities and/or can not find the necessary information about subsidies.
2. Writing of the application as such
3. Identifying and meeting the necessary formal requirements.
4. Publishing the results
5. Finding partners to cooperate with.
6. Establish the budget, staying within the budget, analysing any discrepancies against the results.
7. Communicating with all the partners and the European Commission.

There are many companies today as well as many independent consultants with the sole purpose of working with private and public financing. This is for both practical information and guidance with regards of an area that is so complex and varied subsidies between. A relative discussion around concern- and company taxation, which through its own size, misuse of language and demand for previous knowledge, does not sound like a good plan.

There seems to be a few negative aspects when the need for using an external consult arises, the largest is that a consultant knows so little about the organisation which can effect the chances of the organisation receiving a subsidy. They promise often a lot more then they can actually deliver because of a lack of knowledge that must be known in advance with regards to the overall application for the specific subsidy application. When the project has thoroughly looked at and reported the weaknesses often appear. In the worst cases the organisation can be held responsible and ordered to repay any costs which in turn can lead to them being made bankrupt.

The demand behind the invention is because:
A. The applicants' organisation knows their job area with so much more understanding then a consultant.
B. In many cases the applications are evaluated by other professionals (so called “peer review”), which conveys the information's dissonance doubled up (partly the consultants interpretation of the organisations needs and partly the reviewers interpretation of the writers application.
C. To give the organisations application rules that the writer them self should ignore gives a double effect where the information's dissonance is eliminated.
D. Consultants often charge unreasonable amounts of money and risk even the organisations financial stability by misunderstandings and making the wrong decisions.

In some cases the organisation chose to establish the application by their own hands without feeling the need to involve any outside influences (so called “in-house application”). The plus sides to this are the amount of money that they will save and that they have the over all view the whole time with out the need to wait for contact from any out side consultants, unfortunately this does not always turn out to be such a good idea with the over all application often of a considerably poorer quality. The deteriorated results often come down to these two factors:
E. Low experience of the applications process, resulting in missing formulas. Then you receive the status as “non eligible”. They fall away from the process before the evaluator has even taken a look at their application. The first stage of the process is handled by the commissions other employees.
F. A low insight into the EU's formal rules, social economic principles and policies, respective directorates' preferences and commitments as well as the evaluators' instructions. This means that often producing an application in house falls below the levels of the other applications

To sum all this up regard it as the subsidy consultant has negative sides, high costs as well as a minimal amount of knowledge (in relation to in-house set up). An in-house set up often comprises of a bad insight into the EU's bureaucracy and formulas, and them frequently using a language and vocabulary which is in correct for both the evaluator as well as the employer. In the characteristics of the professionals workers they are thus called, so called “trade idiots”.

Systems are known intended to assist in drafting correct applications. US 2006/0059434 presents a method focusing on not using a master cookie file which contains large amount of information associated with the user to automatically fill in different fields within a form, etc.

US 2006/0136274 relates to an automatic processing of insurance documents to facilitate interaction between different organizations.

None of the above tools do eliminate the problem related to “linguistic preferences”. Accordingly there is a need for further improvement within this area.

### SUMMARY OF THE INVENTION

The object of the invention is to create a system that takes in consideration semantic likenesses/differences and preferences, in combination with generalised “rules and format tools” to efficiently assist in producing a correctly written application should be wrote, and wherein preferably routines are included to enable a processing centre to extract reported data with no need for human intervention, which is achieved by a system according to the claim.

### BRIEF DESCRIPTION OF FIGURES

In the following the invention will be described more in detail with reference to the enclosed figures, wherein

FIG. 1A schematically shows the result of using a traditional methodology, presenting that important portions of information/knowledge will be excluded and that also erroneous information will be included,

FIGS. 1B-C schematically present the advantages with a methodology according to the invention,

FIG. 2 schematically presents a system according to the invention,

FIG. 3 in more detail partly shows included functions of a system according to the invention and also a further system combined with the invention,

FIG. 4 presents a possible first kind of interface for a user being assisted by the system,

FIG. 5 presents the interface for the user of sub sets on a deeper level compare to FIG. 4,

FIG. 6 presents a schematic view of the network architecture of a preferred mode of processing according to the invention,

FIGS. 7A-B show a schematic view of different topological relationship used in the architecture according to the invention,

FIG. 8 presents a schematically graphical view of how the system by means of performing iterations may function to assist in finding “best practice”,

FIG. 9 shows a flowchart of a project in accordance with the invention,

FIGS. 10-14 show an embodiment of a screen presentation of the invention, and different steps during its use, and,

FIG. 15 presents how the MEAs function may eliminate repetition of information.

### DETAILED DESCRIPTION

If the European Union is taken as example, previously, accepted applications (i.e. successfully handled) are the property of the public act, a ground for an extensive empirical data. Of this it is suitable that computer based applications are designed and used. The empirical data will then use to design a “best practice”, as will be described more in detail below.

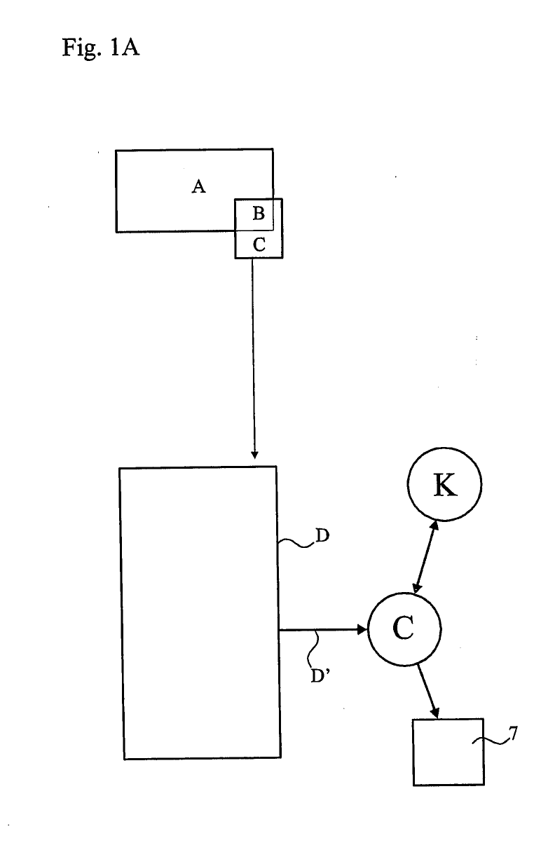

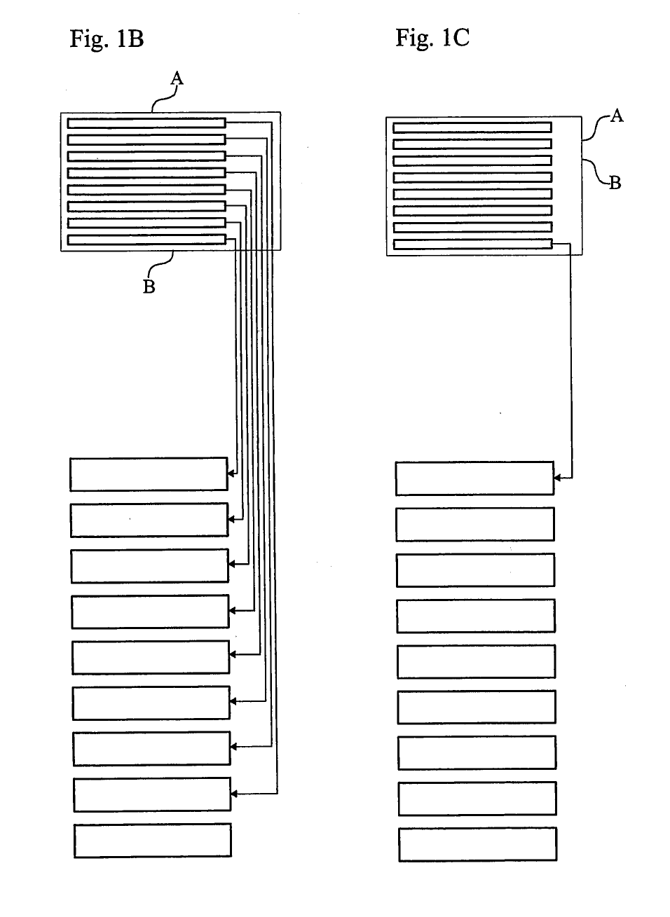

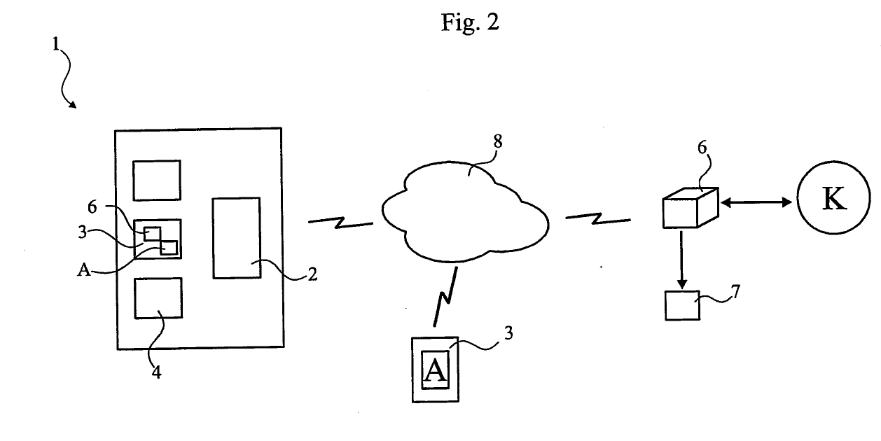

Some basic prerequisites may be defined as (see FIGS. 1A and 2 for ref. numbers below):
1. There is a “best practice” (BP), for an application 7,
2. BP can be analysed and systematized,
3. Evaluating the application 7 follows defined criteria and models, i.e. certain requirements 5,
4. Evaluating applications is relatively homogeneous within different respective subject areas, authorities and/or different groups, i.e. there is some kind of guidelines 9,
5. Deviation can be considered as random and different sized parameters minimise the empires size.

Theoretically it should be the two groups' knowledge and background complements each other in an excellent manner. This speculative frame work is the only factor hypothetically and abstract, where communication between two people is rarely as complete and transparent as the hypotheses requires. The group that has moved furthest in front with an integration of competence is the above named research coordinators or Grant officers within the academy.

It is discrepancies in competence according to the above that the software of the invention primary addresses as a main problem. The assumption in the working hypothesis is that it is more productive to transfer the consultants' competence to respective applicants work competence, sooner then later. The easiest and most plausible explanation is naturally that the subsidies competence is very homogenous, while work competence is varied and essentially different.

The third dimension of weaknesses that arise is the evaluator's independent background and preferences. This third dimension is of course relevant the applications case, between the dimensions it is easy to relate to, extrapolate as well as systematise. Partly because the evaluator should follow the valuations process that the commission has decided upon. Partly because the evaluator is a reasonable homogenous group expert whose preferences and background are often similar. These evaluators are external subject experts, so called peer-reviewers, with genuine academic background. They are familiar with assessing texts/the work/project from outside strict scientific and academic criteria and in addition questioning the commissions' criteria. These criteria—academic as well as formal—are universal.

Another part of the evaluators' independent side is the psychological. The evaluators individual knowledge of the trade person should not effect the over all application. The statement in the text as well as the application should be balanced in both humble and powerful ways (amongst consultants named as “humbleness & power”), a semantic-psychological effect that is universal. The main predecessor is found in the Anglo Saxon judicial system, as well as western countries democratic lobby organisations.

To add more worth in the invention (as indicated in FIGS. 1A and 1B) and not just replace the consults competence with interactive digital competence, the software has been gifted with a knowledge base (A=B) that is much larger then consultants (ca: 20 times larger). After this the database is updated with knowledge in real time with information published by the EU.

Finally a large amount of weight has been placed on the machines cognitive and neuro biological short comings and weaknesses in relating to a large amount of information at the same time. In short the user receives the correct information in the correct moment, and then only the most needed information or instructions.

The software that the invention takes hence incorporates in its paradigm.
1. Specialist's background and competence.
2. Evaluator's background and preferences.
3. The commission's priorities and their assignments to the evaluator.
4. Users cognitive and neurobiological prerequisite.

As shown in FIG. 1A a traditional system comprises a consultant C who has a certain amount of knowledge about how to write an application form, forming the basis by means of which he also takes help from literature D within the field, with the aim of extracting appropriate information D′ to draft a correctly written application, e.g. to obtain financial support to a project. Such knowledge D′ can of course also be gained by talking to colleagues and by looking on the World Wide Web etc, e.g. to try to directly extract relevant information from existing official guidelines 9.

As is evident a book D or any other source of assembled information D will merely contain a limited amount B of the total amount of knowledge A, i.e. the used amount B must be considered as limited. Further, due to individuals C limited cognitive ability only a limited part D′ of the information will normally be used. Further such assembled documentation D often contains incorrect information C (often, ‘negative evidence’) that the author believes to be correct and/or the reader C interprets erroneously. Accordingly extracted information D′ is often incomplete and may often also include incorrect content.

Further, often parts of the application 7, e.g. method-purpose-background is supplied/written by a first individual of the organisation/applicant K, and other parts, e.g. the budget etc. by another individual (e.g. established by the economy department). The results are that the organisation risk losing important pieces of information, due to sub optimised assembly of information, often performed by a further individual, e.g. the consultant C, e.g. due to presenting the same kind of facts by different terms, and/or presenting incomplete tasks, etc.

FIG. 1B shows in principle the paradigm of the invention. Extensive databases 3 (both internal 3 and external 3′) contain large volumes of information (e.g. in external; guide lines 9, laws, case law, etc) that is in real time updated, which as a consequence firstly makes subset A much larger then in FIG. 1A. Secondly subset A in FIG. 1B is (at least partly) obtained from first hand databases, e.g. databases monitored and up dated by the responsible authority, e.g. EU. (The information A that is published is reviewed both in appearance and that they are politically correct as well, relative the EU commission preferences). Thus, using the invention subset C can be considered almost zero.

Moreover, as shown in FIG. 1B the invention uses a system (see FIG. 2) comprising interacting software 4 facilitating that information D″ may be sent out to the user K on a smaller/more relevant scale, i.e. providing limited and relevant information 3″ by interaction 4″ based on questions to be answered. Accordingly the software 4 assists in extracting/retrieving “the correct slice of information” B″ from all different parts of connected databases 3, 3′. These circumstances mean that subset B″ in principal is equivalent with subset A″, i.e. A″=B″.

In FIG. 2 there is schematically shown a system according to the invention. Hence, there is a server 1, with a processing device 2, a memory device 3 either directly or indirectly connected to said server 1 and software 4 installed on said server 1. The memory device 3 (i.e. here defined as also including the interaction with external databases 3′ to include all relevant information A, e.g. via internet 8) includes all information regarding requirements to be met by said application 7. Further it includes software 4 to assist in retrieving relevant information D″ and actively assisting in drafting of said application 7 to meet certain requirements 5. According to the preferred embodiment of the invention said memory device 3 contains linguistic information 6 based on data from at least successfully prosecuted applications 7 and said software 3 being arranged to assist in choosing a linguistic approach based on said linguistic information 6.

Summarizing it is shown that the invention give the user K the correct answers and meaningful information and instructions D″ regarding a variety of different kind of applications.

In principle the likeliness of success for an application 7 can be related to the criteria below:
1. The project as such
2. Application
3. Relations & references
   which need to be considered in the drafting of an application 7, and which a system according to the invention does, as will be explained more in detail below.

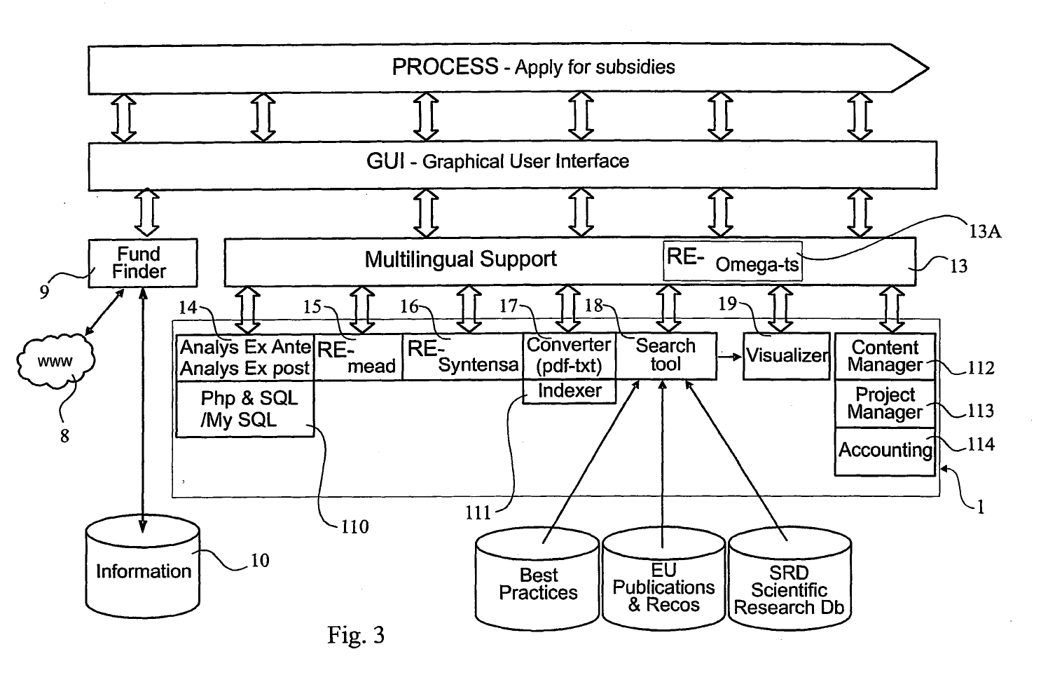

With reference to FIG. 3 there is shown in some detail a preferred system according to the invention, partly including preferred functions of a server/system 1 according to the invention and also a further system 9, 10 combined with the invention,

As indicated the invention preferably is combined with further means of assistance 9, 10, a so called Fund finder 9 which is a user interface that works together with a database “Information funds 10”. That database 10 includes actual/searchable subsidies, arranged by the applications criteria (so called wants/demands in Sweden). Such criteria is amongst others, company size, geographical area, purpose with subsidy and what type of branch the company is a part of, etc.

When using the system in combination with “Fund finder 9” the user K via a graphical interface 6 marks in their profile or preferences the same criteria, resulting in a search engines (not shown) included in “Fund finder 9” coming up with relevant searches as well as the relevant subsidies.

Either directly manually or via the search (by default) through “Fund finder 9” (mentioned above) the user K may activate the system by marking a certain subsidy that the user is interested in. Via the inter face 6 this will activate the server 1 to supply the actual subsidy form/module. A preferred server “content” 3-15 as shown in FIG. 3 will partly hereafter be referred to as “Grant Manager”.

Firstly the server 1 preferably interacts with the user K via a multilingual support platform 13, e.g. comprising a RE-Ω-ts component 13A, which is a machine translator—MT, where the symbol f is just a symbol for the technology that Cap use within MT. Ωts 13A takes care of many functions in Grant Manager, an advantageous one is that all documents regardless of weather or not they are in English to begin with can be compared with and analysed. For example if the user, when filling in a form chooses the word “environment”, it automatically provides information in different languages that also contain information regarding that topic/form. The software thus assists in retrieving relevant information/documentation regarding how the form is to be filled in, e.g.:

Miljö (Swedish)

### Umweld (German)

### Milieu (French)

El medio (Spanish)

### Ambiente (Italian)

It is worthwhile noting that such technology at the moment does not exist on the market. In traditional search engines the user must understand the language within the question or the answers, for ex the word for “miljö”, something that is not needed when assisted by Ωts 13A. The advantage is that the databases become more complete, away from where all the usual documents are translated within the EU—above all those documents that are meant for the national market, or written by a national operator (for example a Swedish subsidy application form sent to Vinnova).

With the technique “Query Extension” all synonyms and relative expressions for the respective manifest will be activated. A search using the word “Environment” should in this case come up with many of these words written below

| | | | | | |
|---|---|---|---|---|---|
| Environment | Miljö | Umweld | Milieu | El | Am- |
| | | | | medio | biente |
| Atmosphere | Omgivning | Atmosphäre | | | |
| Surroundings | Natur | Lebensbereich | | | |
| Location | Yttre | Lebenskreis | | | |
| Setting | förhållanden | Lebensraum | | | |
| Upbringing | Omvärld | Sphäre | | | |
| | Värld | Nature | | | |

Further the server 1 preferably includes a component called “Analysing ex ante” 14, which is really just a check list of the preparations that the applicant should go through before the actual application 7 is written down on paper. The Analyse is comprised of a specific quantity of questions the applicant needs to answer to, and by that we mean objective and summarized that give details of the present situation. The user answers the questions on a scale of one to four, depending on how different each answer is relating to the company/project in question. Depending on which subsidy has been chosen, e.g. via “Fund finder” 9, an algorithm is activated assisting in finding out where the users answers show what strengths and weaknesses the company has. After this comes a plan of action for the organisation, concerning what things need to be addressed before the application is handed in.

The focus on this module 14 is the project as well as the relations meaning everything that the company needs to go through—except the application 7. The aim of this is to quantify (rating from 1 to 4) for example, the variety of European collaboration that exists, previous research projects, personnel policy, management team, board backup, CSR, risk awareness, internal budget constraints etc.

In short, the ex post module is a set of evaluating preferences, defined by the financing organization (most often the EU Commission in Europe). Those preferences changes depending on the type of grant or grant-program. In the 7^{th} framework the preference is heavily focused at scientific cutting edge and collaboration in European in partnerships. In a program by the social fund (ESF), the preferences are set at equality, social integration and competence, and finally the structural funds focus mainly on rural development and environment.

Given the answers the user K has defined in the ex-ante module, and the preference set by the financing organization in ex-post module, there will appear a variety of dissonance (the questions in ex-ante are defined to match the themes and focuses of the preferences present in the ex-post module). As an example, if the user types that he has no former experience in advanced research, and a poor management team, this will appear as weaknesses IF the user is aiming for the 7^{th} framework. If the user is aiming for ESF funding, the research experience and management team are not as critical, hence they won't appear as weaknesses.

The analysed module eventually any questions that the company may think of during the application process, The company in this case saves a significant amount of time, as well as gaining information about which parts more action should be taken with before any further action is taken with them.

The technology used in module 14 may be Php and SQL, as shown in FIG. 3, no 110.

The search tool (18 in FIG. 3) is an interface for management of the databases (3,3′). The search tool is essentially a part of the GUI (6 in FIG. 3).

The database labelled “best practices” contains applications for grants, which has been awarded with financial aid. The assumption of GrantManager is that such applications are written correctly and do not lack any essential part or description, and that the applications are written correctly and professionally. The documents in this database make up the linguistic and semantic reference point for the help-functions in GrantManager.

Further, the database “Best Practices” forms a kind of a reference point for the user of GrantManager in the way that they describe what has already been financed. Hence, the user can relate to those facts in the writing of their own application. If they for instance are proposing improvements on subject, they can show that similar work already has been financed, thereby showing that the subject is relevant and of importance to the funding organization. If nothing similar has been done on any particular subject, the user can show that the approach is innovative and/or has been forgotten by the funding organization. Whatever the status of the particular subject the user is aiming on (i.e. weather it has been awarded with funding or not). The awarded applications are public documents for the most part.

The second database labelled “EU publications and recommendations” basically contains all that has been written and published by EU, hence making a reference point for the user K, on what ant why the evaluator of the application should pay attention to the application and approve it. In the same manner as the first database, the user K can relate and give reference to any recommendation from EU in the application. This is effective since it shows to the evaluator that:
the applicant/user K is familiar with the domain of the proposed application to the extent that the user K knows of all recommendations and publication on that matter. This is probably by far exceeding the knowledge and insight of the evaluator.
That somebody in the EU administration, most probably superior to the evaluator, clearly and publicly has expressed the relevance of the subject/domain which the user K is proposing.
Most probably, the EU has conducted an investigation on the subject and thereafter the subject has been case to dissection and evaluations by other EU officials, which is the normal circumstance before any publication.

The third database, labelled “Scientific research”, is a database containing published research reports and thesis's by the global research community. It works on the same principles as the databases described above, and gives the user a possibility to relate the proposed application to global cutting edge research. Either the subject which is proposed of has been addressed prior by someone, which can add a perspective in the application, or the applications takes on further research to the next level. Or the subject can be totally innovative and unexplored. There is a possibility that the proposed subject and project already has been done by others. In that case, the user K gets a notice that it is possibly preferable to terminate the application for financing, in order not to waste time on something which will probably be denied. Or to simply add a new perspective and/or rephrase to subject.

In short, the configuration of the modules 18 and 3,3′ in FIG. 3 (search tool and databases), gives the user K a tool to fulfil the criteria's of a application for a grant:
1. The project as such
2. Application
3. Relations & references

### (See FIG. a)

The user can benchmark previous applications (from database 1), and relate to previous global state of the art research and EU recommendations (from database 2 & 3). To prepare for the managing of the project as such and the users K basic ability to deliver the project according to EU standards, the user K will use the module 14 (analysis ex Ante & ex Post).

Further the server 1 preferably includes a component called, RE-Mead, 15. In its most basic form Mead 15 is many different sources-automatically summarized. This involves many different documents summarized and then shown as a shortened text.

This module 15 is used like a tool that can diagnose with the help of a database, which means that the module shows everything that is within the database with an optional description, e.g. +Environment+Great Britain+Coal+Bereavement, giving a short description about the chosen subjects is presented. The writer's compromise levels are left up to themselves completely.

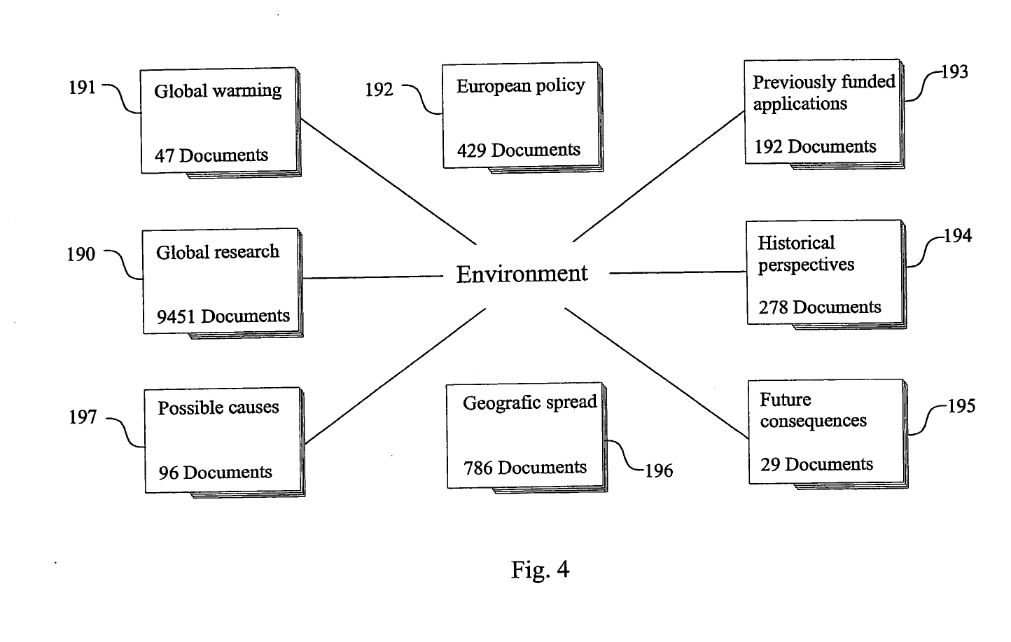

Alternatively a user K can just search for the word ‘Environment’ and with the help of the module visualizer 19 receive a picture like the one shown in FIG. 4.

The user can now right click on a subset document 190-197 and get a summarized description about it. If Great Britain, bereavement and coal exists in a summary, the user has found the right documents. This is called Mead-piped.

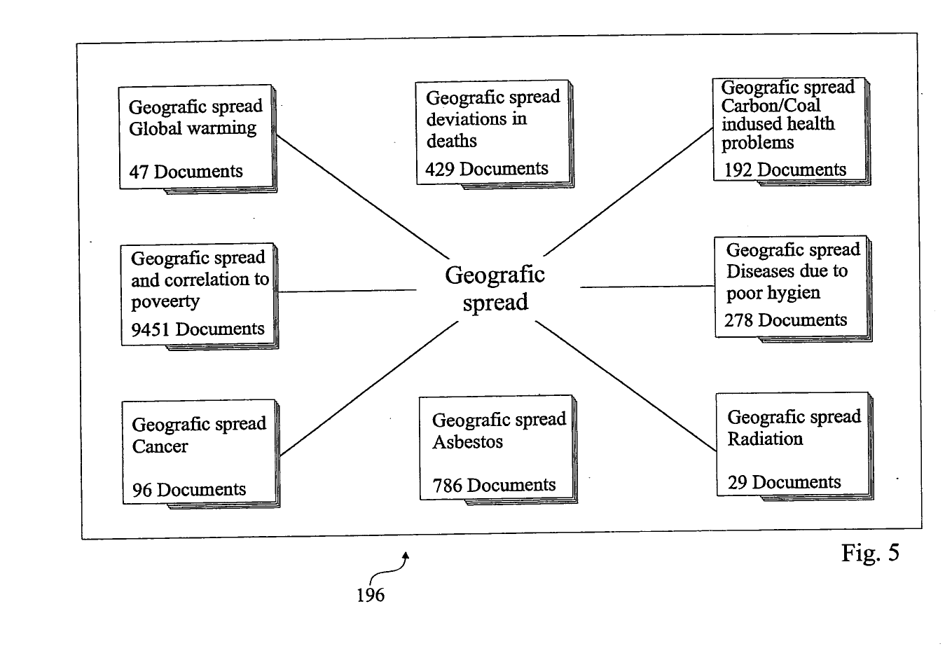

Alternatively the user can double click on a subset 190-197 and then perform a more in-depth database search. The user can focus on different criteria whilst searching, either focus on Great Britain, bereavement or coal, by double clicking on the subset that most likely contains the chosen criteria. Presume here that the user chooses the subset Geographic spread; 196, he will be presented a further subset as shown in FIG. 5.

One of the most innovative parts in GrantManager are the Indexer 111, the search tool 18, the visualizer 19, (described in Methodology description below) and the ability of these modules to manage the information in the databases and present them to the user

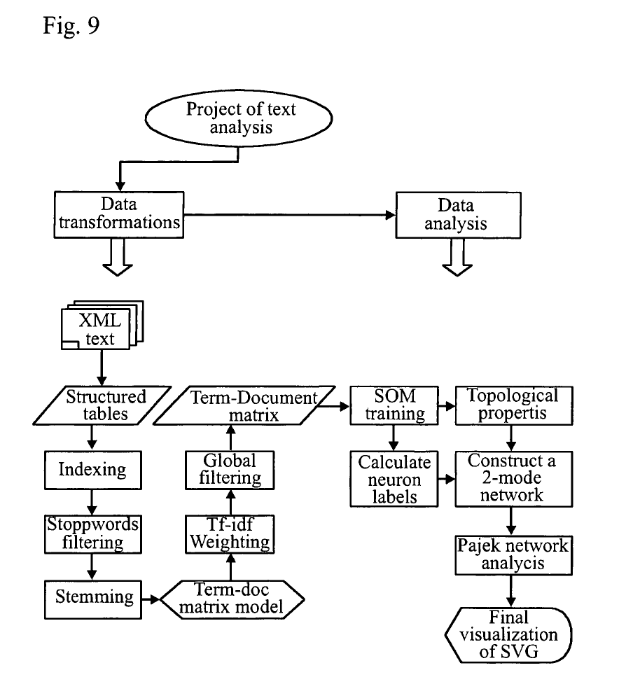

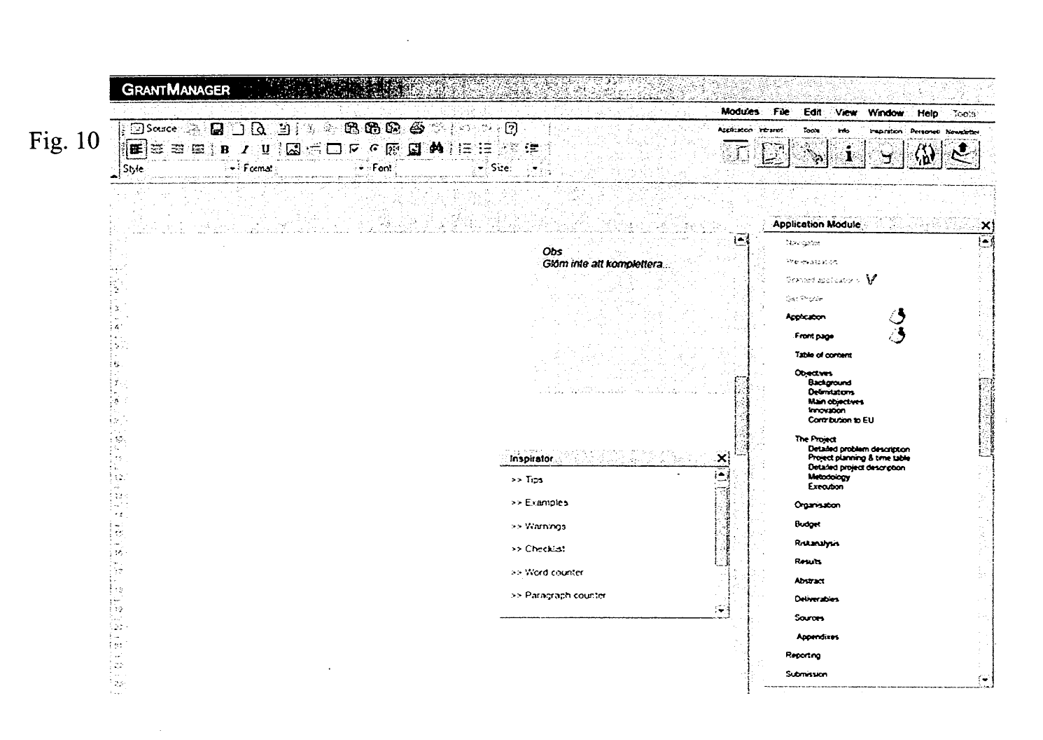

FIG. 3 illustrates the innovative parts regarding the architecture of the software (see Fig. b). Before describing the algorithms of the software and innovative parts, it is referred to FIG. 9, wherein we illustrate the workflow, i.e. the flow ranging from identification, information extraction, indexing, vectorization, visualization, and finally recreation. Each function is explained in the methodological description below. The flowchart presents two main processes: data transformations and analysis. Each process involves several subprograms. This project achieves a final map of SVG with the information of relationships between all the original XML texts based on the content.

The following part gives a brief introduction about the whole transformation with four processes. For the first process, all XML texts are decomposed into structured tables in a standard relational database. Then several transformations are applied to these original tables based on the standard search engines.

First, every text is filtered out stop words (such as she/that/it and so on) by using stop lists, since filtered texts without “functional words (are not important for communication)” will be clearer and more useful. Then, stemming processing is applied to these texts, which is a linear stemmer to remove the non-significant parts to the words and transforming them to their stem (basic form, for example transforming running to run, and reading to read etc., as well as removing tempus forms will be, has been etc.)

The next process is to construct a term dictionary from document collection in two steps: get all unique words in the document collection and read the whole document collection again. The result from this process is a dictionary which has only two columns, term vocabulary column (m=27576) and index of terms.

A m′n matrix must be defined in the third process, since the further process will transfer this matrix to build a term-document matrix based on stemmed text documents and term dictionary. Such matrix's rows and columns correspond to terms and the list documents.

In the next step, the “tfidf” weight is used to calculate the frequency of a term in correspondence with document as the entry of matrix. Terms contain all the information of texts (mathematically speaking); it acts as a diplomat for text analysis. Different terms in each document has different semantic relevance.

In order to construct an abundant model, the terms will be regarded as having the same important element; the term-document matrix keeps an original, and each row can be taken as a vector. In this way the matrix stands for a vector space model.

Before the term-document matrix is transported into SOM, a global filter is applied to this matrix for a good model performance by reducing dimensionality and sparseness. In this sense, 100 document samples and 100 term samples have been chosen randomly to do matrix filtering. Meanwhile, terms with high appearance, more than 250 will be deleted as well. After reduction of terms, the documents are reduced as well. Documents will be filtered out with less than 200 terms, and documents containing more than 400 indexed terms as well. The resulting global filtered term-document matrix consists of 320 documents and 3473 terms, i.e. there are 320 input vectors with 3473 dimensions in space (in this example). The filtered term-document is then exported into SOM in this.

Before the training phase, output vectors should be initialized. Based on linear initialization, vectors are initialized in an orderly fashion along the linear subspace spanned by two principal eigenvectors of the input data set. To this end, the map size of SOM in two-dimensional grid should be defined first; The numbers of neurons determines the scale of the mapping, which can affects the quality and performance of the SOM, that is the size of the maps exceeding the number of documents that is sufficient for us to detect the cluster structure of SOM.

This exemplified project is trained on three different map sizes of 10′10, 20′20 and 30′30 SOM. It turns out that the map of 100 neurons (10′10) has the lowest concept intensity, meaning the degree of similarities or dissimilarities of neighbouring neurons is low; correspondingly the 30′30 map (900 neurons) has the highest degree of similarities or dissimilarities of neighbouring neurons, but the cluster structure of SOM is not so clear, meaning it may be prone to errors; while the SOM of 20′20 (400 neurons) displays proper neural density and clearer cluster structure.

So this exemplified project defines a 20′20 SOM as a reference point and each neuron has six connected neural neighbourhoods (dendrite clusters) which can preserve the topological relationships of input data during training.

The training processing is performed in two phases; initial training and final training. The initialized output vectors are trained based on input vector. Therefore, individual documents are assigned to the ‘closest’ neuron, and a single neuron may relate with several documents. The figure below explains how the input data relate with the SOM in this project, for example document ID 10 and 70 are assigned to the neuron (1, 6) on SOM.

SOM's are used for analyzing complex structures of communication networks. However the resulting visualization of SOM are prone to lack of communication and scalability, and with labels attached to SOM gives too little interpretable meaning and are hard to locate. To overcome this, we construct a 2D visualization of information spaces that addressed complexity and automation.

This project is aiming at providing a comprehensive visualization of relationships between documents, and such relationships have been revealed by the linkages between documents and neurons on SOM. Thus the next step is to set out such linkages, which can be analyzed as network.

Meanwhile Pajek is software for network analysis, and its island algorithm can calculate each neuron and their closest documents as an island, which is disjoint from each other.

For the final visualization, this project will adopt SVG, since SVG can offer powerful and simple approaches for visualizing 2D or 3D objects and scenes, while 2D visualization is adequate in most cases, and allows the user to operate at most possibilities. What's more, SVG enables the user to interact and communicate with the graphic model.

Before Pajek analysis, all neurons are labelled. Labelling is a difficult task, since one need to find terms which should be specific enough to meaningfully distinguish the neurons from others, but at the same time general enough to actually be representative of most of documents belonging to this neuron. It is important to differentiate general computed labels from specific. Considering more specific, this project uses a simple labelling algorithm, which easily calculates the sum number of occurrences of terms in these documents which has the same BMU, and then three of these terms with top count of occurrences are taken as the label of this neuron.

### 1. Methodology Description

The following description illustrates the methodology in use of GrantManager. Although similar principles have been in use in other fields, it has never been used in combination with a text vector indexer. Basically, the traditional use is in rural and demographical statistics generation and extrapolation and in later years it has been applied into marketing research.

The methodology in GrantManager uses a text vector indexer to apply a conceptual and linguistical value to the words, the sentences and to the meaning of the texts from the databases in use. Using this vectorindexed values, the GIS/SOM system can combine different words, sentences, text and concepts from the databases, and finally use/reuse them according to preference or the predefined software framework in the GrantManager.

This process is a mimic of a human expert with unlimited knowledge, limited only by the size and content of the databases. In it self, the TVI-SOM-GIS combination is a artificial neural network analysing and/or visualising high dimensional information in low dimensional views and to low dimensional viewers with limited cognitive capacity.

In a sense, the GrantManager is an Artificial Intelligence with analytical properties and the ability to learn from others mistakes and successes.

### ABBREVIATIONS AND NOTATIONS

### BMU Best-Matching Unit

### EPS Encapsulated PostScript

### GIS Geographic Information System

### PCA Principle Component Analysis

### PDF Portable Document Format

### SOM Self-Organizing Map

### SVG Scalable Vector Graphics

### TVI Text Vector Indexer

### UMatrix Unified Distance Matrix

### VERL Virtual Reality Modeling Language

### W3C World Wide Web Consortium

### XML Extensional Markup Language

### b BMU of Input Vector

### Dist Euclidean Distance

### H Neighborhood Kernel Function

L₍ₜ₎ Learning Rate at t time

### Xᵢ Reference Vector of Neuron i

### Vᵢ Sample Vector i of Input Data Set

### 1.1 Methodological Background and Introduction

Textual data is commonly appearing in PDF files, spread sheets, word files, PowerPoint files, text files, emails and many other types. Such large text databases potentially contain a great wealth of information. Moreover, the amount of accessible textual data has been increasing rapidly. However, text analysis requires a wide range of knowledge, like computer science, mathematics, library science, information science, cognitive psychology, linguistics, statistics, and physics.

Currently the existing information retrieval technologies have limitations, for example users must have some specific ideas and certain knowledge for searching information and the results are frequently too complex and provide less comprehensive vision. To address these problems this project applies self-organizing map (SOM) technique to explore the structures from the data sets, by clustering and classifying all the documents based on the content. In this description Pajek analysis software is illustrated for producing the final scalable vector graphics (SVG) map which describes the classifications and relationships of documents.

### 1.2 The SOM—Self Organising Map

SOM is a special kind of neural networks that can be used for clustering tasks and visualizations of high dimensional-data. It maps nonlinear statistical relationships between High-dimensional data into simple geometric relationships; usually SOM is a two-dimensional grid which involves two layers of neurons: an input layer and an output layer.

In essence, the SOM provides a way to visualise high-dimensional information in a much lower dimensional space, but with preserved initial topology and context. An illustrative metaphor of this would be highly compressed summaries of 15 books, summarised to 10% of their original size. Obviously, one would need only 10% of the original space to store the books. However, regarding computational power on will need much less than 10% of the original power required, given that any combinations of all or any of the 15 books can be subject to analysis. Hence, the computational power required for analysis increases with the square of the page numbers in use.

In order to summarize and simplify, the SOM would store and compute approximately 14-15% of the original size, which would be an equivalent. However, the SOM would keep all the information from all 15 books, 100% of the pages. This is achieved through eliminating irrelevant information and repetition of information—but with a mark/note of what is eliminated and how to retrieve this information. Then, one could proceed in more dimensions, eliminating repetition when all the books are regarded as one unit. Each concept can be mentioned in its full extent in only one book, then a special note would appear in any other book when this concept is mentioned. In any other book of the 15 exemplified, or in any book or file in a library—physical or digital, in any language, and in any way of vocabulary, way of expression or other semantic statement.

On top of this, the SOM can “understand” the statements/concepts and start to “learn”, actually through employing statistical extrapolation. If the concept/statement 1.0 is followed by 2.0 in most texts, SOM will learn that 2.0 probably is a result of 1.0, alternatively it is a prerequisite, all depending on the statistics of the appearance of the combinations; how frequently does 1.0 appears before 2.0, how frequently is it the opposite, how frequently does 1.0 appear but is NOT followed by 2.0, how frequently is only 2.0 present? When a rule is constructed, it can be called 3.0, a new concept eliminating 1.0 and 2.0.

1.3 Network Architecture

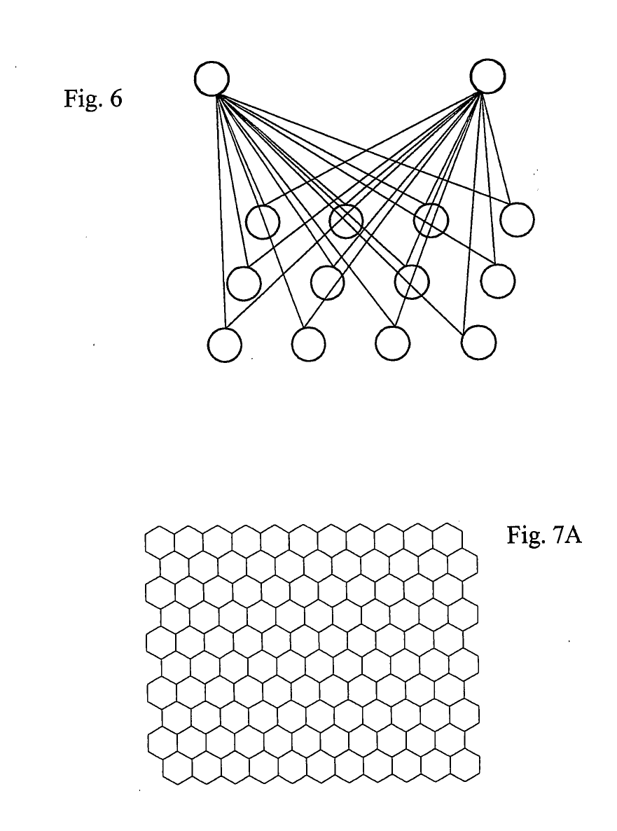

SOM consists of neurons or nodes located on a regular, usually 2 or 3dimensional gird; for easy interpretation a two dimensional SOM as an example is interpreted in this presentation. In 2D lattice network, each neuron or node is fully connected to the input layer, thus this input layer acts as a distribution layer (see FIG. 6).

Each node in the network contains a model vector, which has the same number of elements as the input vector, so if the input vector V of n dimensions: V 1, V 2, V 3, V n, then each node will contain a corresponding weight vector X, of n dimensions: X 1, X 2, X 3, . . . Xn. The number of input dimensions is usually much higher than the network's dimensions.

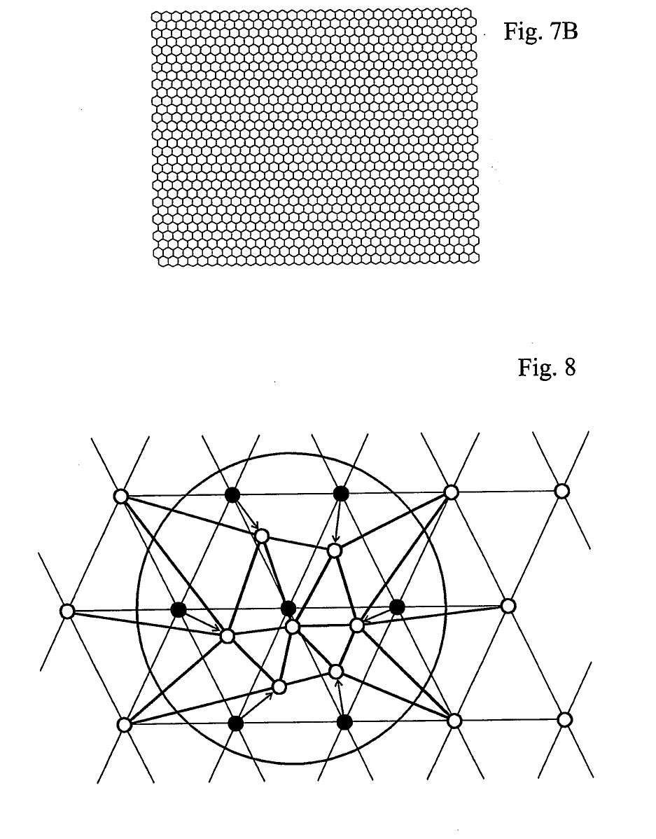

SOM's neurons are connected to adjacent neurons by a neighbourhood relation dictating the structure of the map. Commonly, these neurons can be arranged either on a rectangular or a hexagonal lattice. The next figure shows 30′30 and 10′10 two different sizes of neurons in hexagonal grid, as shown in FIGS. 7A and 7B.

### 1.4 Learning Algorithm

The goal of learning algorithm, as schematically presented in FIG. 8 is to update different parts of output layer for acquiring similar patterns of the input layer, by optimizing the node weights to match the input vector. This process involves initializing and training, which occur in several steps:
1. Each node's weights are initialized randomly or linearly based on the input data.
2. Randomly chose a vector from input data as the example vector.
3. Get the Best Matching Unit (BMU) by calculating every node's weights which is most like the example input vector. One method to determine the BMU is to calculate the Euclidean distance between each node's weight vector and the example input vector, the node with the weight is closest to the input vector is defined as the BMU, the Euclidean distance is given as:

$$Dist = \sqrt{{\sum }_{i = 0}^{i = n} {( {V}_{i} - {X}_{r} )}^{2}} \qquad [ 3.1 ]$$

Where V is the input vector and X is the weight vector of the node
4. The radius of neighbourhood of BMU is updated each time step, from large to 0. After the BMU has been determined, all BMU's neighbours should be found and these nodes' vector weights will be altered. The area of the neighbourhood shrinks over time based on the Kohonen algorithm that means the radius of BMU's neighbourhood shrinks over time. The exponential decay function is given as:

$$σ ( t ) = {σ}_{0} exp ( - \frac{t}{λ} ) \qquad [ 3.2 ]$$

Where σ₀ denotes the gap (with) of neighbourhood at time t₀, and λ denotes a time constant.
5. Any node within this radius is considered as the neighbour of BMU, and the weights of neighbouring nodes are adjusted to make them more like the input vector. These nodes' weight vector adjusted according to the following equation:

X(t+1)=X(t)+L(t)H(t)(V(t)−X(t)) [3.3]
Where L is the learning rate which is decay over time, H is neighbourhood kernel function, and X and V respectively stand for the output weight vector and input weight vector. So it is clearly to see that both learning rate and learning effect have to decay over time. Learning rate can be calculated using the below function:

$$L ( t ) = {L}_{0} exp ( - \frac{t}{λ} ) \qquad [ 3.4 ]$$

A application of Gaussian neighbourhood function is used to calculate the effect of learning:

$${H}_{ji} ( t ) = exp [ - \frac{{Dist}^{2}}{- 2 {σ ( t )}^{2}} ] \qquad [ 3.5 ]$$

Where Hⱼᵢ stands for the amount of influence a node's distance from the BMU at t, Dist is the distance between node j and node i, s (t) is the width of neighbourhood function.
6. Repeat step 2 for N iterations till the convergence is reached. That means mᵢ(t+1)=mᵢ(t), for t→∞ until the reference vectors are no longer changed in further iterations.

### 1.5 Some Important Properties

Foundationally, the above learning algorithms can be concluded in two processes, vector quantization and vector projection. In vector quantization, from input vectors to output vectors it reduces the number of data points, but still representative SOM performs nonlinear mapping, so it can be explained as elastic net which folds the input data and fits the distribution of the data in the input space.

SOM is resultful when the reduced data can be representative of the input data. That is, it is prerequisite to decide a suitable number of reduced data. Many researches have proved that such representation is accurate for the large number of output data, and small number as well. Hereby SOM roughly follows the density of input data. In addition, when dealing with the reduced data set from vector quantization, the computational complexity of subsequent steps are reduced; and quantization averaging removes noises in the data, reduces the effect of outliers and reveals big structures.

Vector projection aims at preserving the topology or local structure of the input data. In this sense, the input vectors with short Euclidean distances will be projected to as neighbourhoods on SOM. The combination of vector quantization and data projection can be done sequentially rather simultaneously as in the SOM.

### 1.6 Variations

A variety of versions of the SOM algorithms can been presented. The goal of some algorithms is to adjust the weights of output vectors to correspond to the training data, and neighboring output vectors become similar to each others. And some others aim at reducing the computational complexity of the SOM, since the speed of computation is an important element when the training data is really large. Also, SOM has additional variants for other application purposes.

The batch version of the SOM has fast algorithms; the incremental regression process defined by equation [2.3], [2.4], and [2.5] can be replaced by the following batch computation version:

$${x}_{i} ( t + 1 ) = \frac{{\sum }_{j = 1}^{N} {h}_{bi} ( t ) {v}_{j}}{{\sum }_{j = 1}^{N} {h}_{bi} ( t )} \qquad [ 3.6 ]$$

Where b is the BMU of input vector vⱼ. The new weight vector is calculated without the learning rate 1 [2.4], so there has no convergence problems and yields more stable asymptotic values for the ix than the original SOM. Also this process is iterative with a single data vector at a time. Particularly, this algorithm is successfully applied to the output vectors which weight values ordered already.

Treestructured SOM is an especially fast version of SOM for speeding up the search of the best matching unit. Each level of the tree is consisted by a number of output vectors growing exponentially. The training is repeated using the knowledge about the BMU from this layer to next layer. This clearly reduces the computational complexity when compared with the basic SOM.

Hypercubical Self Organizing Map allows higher dimensional gird lattices that take hypercubical form comparing with other systems, which locate a 2dimentional regular gird. The basic idea is starting with a small SOM, the grid is grown periodically. And the dimension is updated by adding rows, columns to existing dimensions or new dimension. Therefore, the lattice can be 3D, 4D, or lager.

In the following a possible example of use of the invention will be described, based on an assumed case, wherein Jane Doe a biology student, is preparing her PhD-thesis at a major university. For the last 4 years of her doctoral studies, she's been focusing on environmental issues regarding applied technological biochemistry.

Her research in that area has targeted the potential use of nana-structures compounds with high affinity to the Freon molecular structures, thus being able to saturate it by replacing a missing electron. As such, it would be possible to stop a lot of hazardous waste products, right at its source (regardless if the source is a industry or a consumer refrigerator).

A final research experiment is needed to confirm her preliminary in vitro trials. Unfortunately, such a setup would cost at least 3 million [symbol] . Jane is desperate, for the sake of the thesis and the environment. Her supervising professor tells her to seek external finance, either in the form of grants or sponsorships by corporations. However, a browse in the EU website shows no possibilities of navigation. Her search for “environment” shows 389 215 related documents, a search for “biochemistry” 122 915 documents and the extended search “+environment+grant+biochemistry” shows 0 documents.

Unfortunately, the EU uses an index based search engine, which finds all the documents where the asked word is mentioned. Hence, most of the found documents are totally useless for Jane's purpose. And even if she found a grant to apply for, she has no clue at all how such an application should be written. All her colleges discourages her, they mostly have bad experiences from grant financing. Jane is really annoyed, she is studying advanced science, not fictional literature or authorship.

However, the newly hired scientific coordinator at the university tells her about a truism regarding public finance; most people applying for the first time fail to receive financial aid because they don't know what they are doing. Most of them end up hating the EU. Those people who don't end up with hate, end up as consultants. The coordinator has a license for the use of GrantManager, an interactive software helping the applicant in the process of writing. He gives it to Jane to try it out, and she logs on. (see FIG. 10)

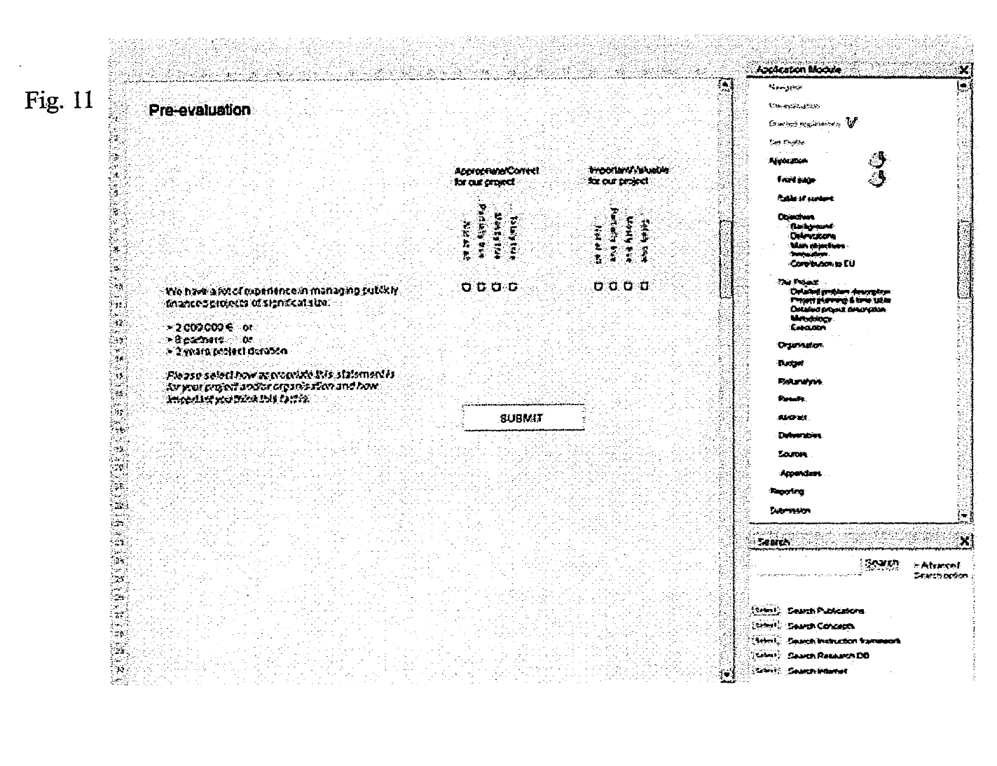

The first step in the software is called ex ante, and the software is posing a lot of questions to Jane concerning her project. (see FIG. 11) After 30 and some questions, Jane receives a status report regarding her chances of receiving a grant, and how she should improve them.

The software concludes that her chances are small, but encourages her to follow the presented advices. She receives 14 tips, and the most important are
1. to find suitable partners in this area, other universities in Europe as well as private corporations.
2. to activate her supervising professor more in the research/project, mainly because his name and experience. This will also help in attracting the other partners.
3. to find a professional manager to run the project, one experienced in similar projects with many partners
4. to introduce a preliminary contact with the following organisations;
   The governmental organisation Vinnova
   The EuroInfo Center
   A scientific officer in the EU commission

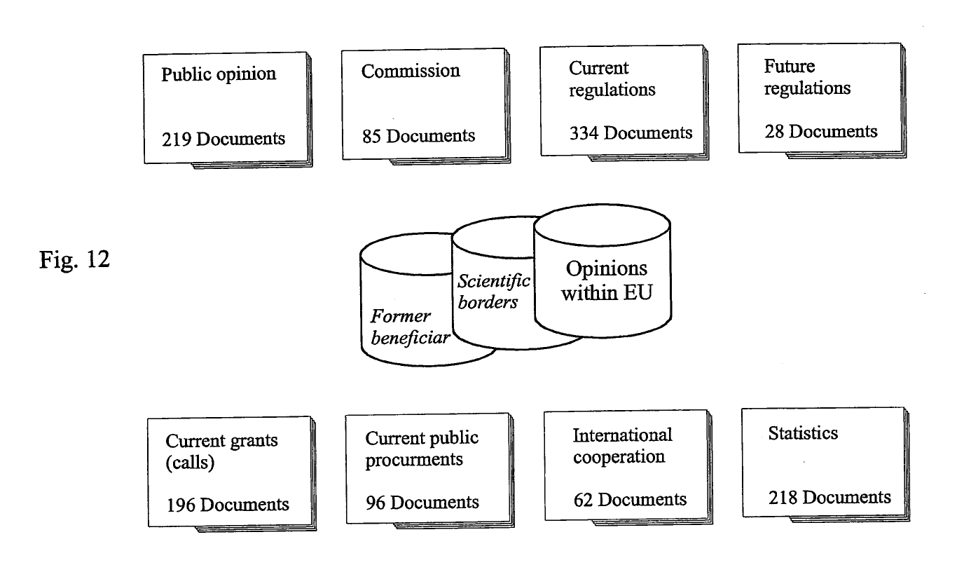

Then, Jane enters her search in GM as “environment+biochemistry” (without the term “grant”, obviously). After 7 minutes, she receives three sets of data entries, see FIG. 12 labelled as:
1. Opinions within EU
2. Scientific borders
3. Former beneficiaries

Every entry is displayed as a database with ramifications, as illustrated in FIG. 12.

Jane then double clicks the folder labelled “commission” and receives the question if she wants to open it or to summarize the content. She chooses summarization to get a first overview. GM asks for summary compression level, keywords and other discourse parameters. After choosing a setup, Jane receives a summary of the whole folder.

She is relieved, because a text from the Commission usually contains about 150 pages, most of them referring to one another and therefore repeating a lot. In GM, every concept is only presented once. All repetition is eliminated, as well as less relevant texts. The presented overview is merely 30 pages, containing the most relevant claims and arguments. She is also interested in the general opinion on “environment” and “biochemistry” respectively, in order to know how to focus the application (to pitch the arguments). GM analyses the previous findings and systemise them in two groupings; environment and biochemistry respectively. It turns out that the opinions of the commission regarding environment is much more positive than the opinions regarding biochemistry¹. Hence, Jane should pitch the application toward environmental issues as for the objectives, and consider biochemistry as merely a tool, a way to achieve the environmental objective/goal. ¹ Shown as fluctuations in the different documents, which are large as for environment. The analysis of large fluctuations are that the commission are both horrified by the environmental threat (negative opinion), and very positive about all initiatives in the field.

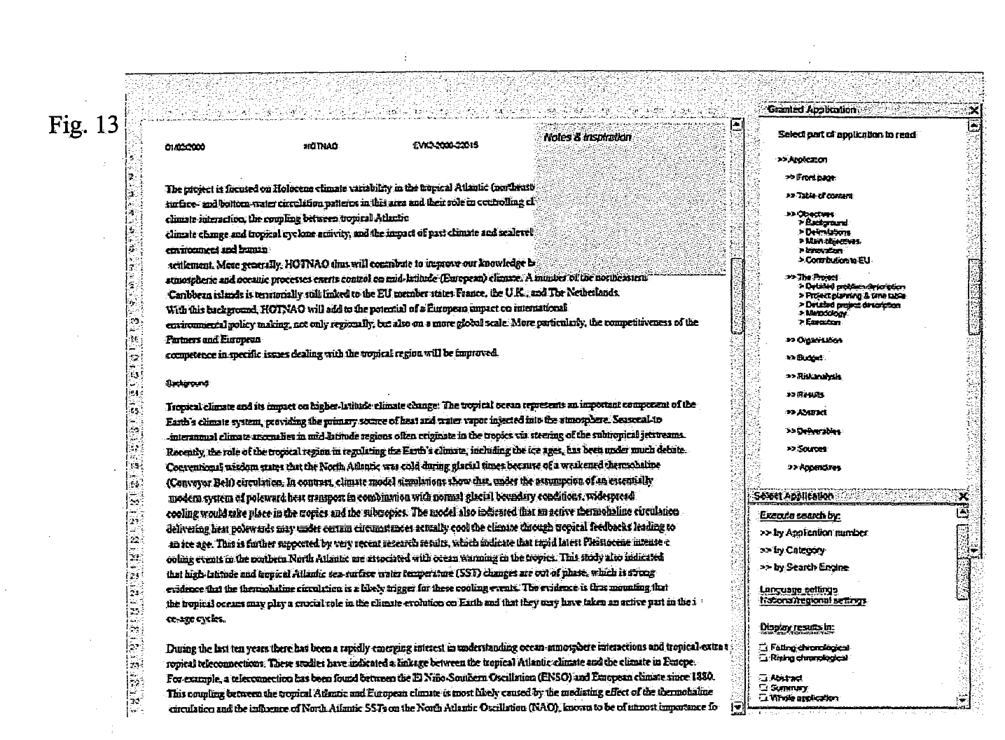

Jane is uncertain in how she should proceed, so she activates the GM wizard. She receives the advice to paste in a small description of her project in the GM, and then to activate the “syntensa” tool. In doing so, a set of templates appear in the GM main window (see FIG. 13).

The GM suggests that the most suitable grant is within the 7^{th} framework, and tells Jane that the most important parameters regarding the success are crucial. In principle the future of the application can be judged by the criteria below, which have to be fulfilled second to none.
4. The project as such
5. Application
6. Relations & references

### (See Fig. a).

For Jane's project, that translates to
1.1 The overall impact of the project. What are the benefits, how large are the benefits, who will benefit? As for the potential impact, why is Jane's suggestion more suited than other principles, i.e. why should Jane be financed and other projects denied?
1.2 What are the chances of conducting a successful project, why is the project setup that Jane is proposing the most suitable, what are the risks, how will the project manage the risk?
1.3 Future use and exploitation of the findings, are there any plans on how to continue the project after the financed period, and how to make use of the outcomes.
2.1 Is the application correct, is there a “fit to call” and is there a fit to the policy and striving of Europe? Are those fits correctly displayed in the application?
2.2 Is the application complete, are all questions answered and all accounted for, is all transparent? Is there a clear logic between objectives-outputs-outcomes? Are they reasonable?
2.3 Is the project cost effective? Is Jane going to make proper use of the grant? Is the money asked for enough to achieve all that is proposed?
3.1 How does the proposed project relate to previously founded projects, how does it relate to global state of the art in technological excellence?
3.2 How many partners (universities, companies) are involved in the project, how many other organisation are willing to risk their own money in the project, how many professors are willing to risk their name?
3.3 Is the project run by somebody experienced in such projects with all the demands which are inherent to public financing and multi-partner and multi-cultural research teams?

All the parameters above (1.1-3.3) are possible to click for further explanation, and instructions on how to fulfil the demands.

To find all relevant information for writing the application, GM uses the databases and the description Jane wrote of her project. The description is translated to a contextual vector by sentence module, and all documents in the databases with proximity to Jane's description are presented to her.

When Jane is accounting for the relevance of her project, she uses the database called opinions within EU, which is consisting of all documents published by all directorates in EU. Jane is once again evaluation the opinions, and she is selecting the documents with the largest deviation in valence² and asking for a presentation from GM with the most recent documents first. She can now argue for her case and refer to documents and cited politicians and public servants. She knows that few application evaluators dares to argue against the whole community of EU, as in both elected politicians, peers and colleagues. Without GM she would not have found the correct documents and not been able to sort them according to valance. ² As in total “emotional value/expressed opinion”

When she activates the database called scientific borders (see FIG. 12), Jane gets an overview of all research being published in this particular area so far.

### (See Fig. c).

She now has the possibility to relate her project the scientific borders and best practices internationally and in an European perspective.

The research in the database is systemised in groups depending on where it was originally published. Hence, Jane knows that research conducted at MIT for instance, is defining absolute scientific excellence. She also knows that research conducted at Europe's networks of excellence are the most relevant that she has to relate to.

### (See Fig. d).

When she is using the database named Former beneficiaries (see FIG. 12), she can relate her project to formerly financed projects, which is important both in the application, but mostly for the eventuality of a hearing (if the project gets a preliminary go ahead, but before the definitive approval). At the hearing she will be asked about previous similar projects, why those early projects did not do what Jane is planning to, what they would think of Jane's project, why they are not part of Jane's current project, what Jane has learned from their experiences etc.

For the other part (writing the application), which is crucial as well, Jane is actually receiving a blueprint of an application which can be regarded as excellent (otherwise it wouldn't have got the approval).

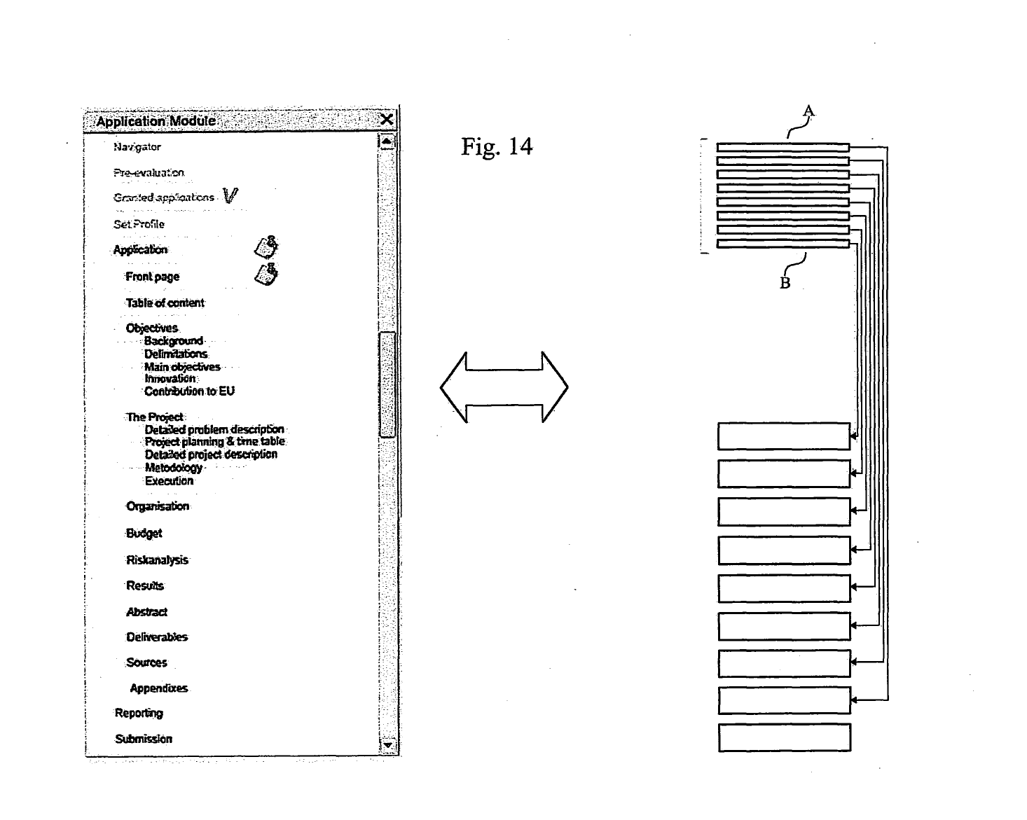

When writing the actual application, Jane uses the menus in GM for instructions and advices, besides the previously approved applications. Hence, she gets both instructions on what and how she should write, as well as examples on how other wrote before her. The database as well as the instructions are dynamic in the way that they change depending on what part of the application is worked upon, as indicated in FIG. 14. She then receives only instructions, tips and examples on what is relevant and crucial for the specific task at hand.

In a sense, Jane feels that the level of interaction to the software enables her to focus her writing, and she's not disturbed by things that are not acute. When she gets a thought, idea or question, there is an “interactive post-it note” where she writes it down for future use.

There is also a checklist where she can mark all assignments needed in the application. The risk of her submitting the application undone has therefore significantly decreased.

In the following, some further possible uses of the technology of the invention will be presented.

The main problem of information today is the enormous surplus. The availability of information has expanded in proportion to the technological development, thus far exceeding the processing power of the human brain. There are very small possibilities to find and evaluate the information one is interested in. The main reasons are
Most of the information is merely repetition, paraphrasing or other types of rewriting already published information
There is currently no possibility to value or rate the correctness of information. The principles used by search engines are overrun by SEO (search engine optimization), used by publishers looking to sell something or to influence people in other ways. Those publishers aiming to present correct information seldom focus on SEO at all. That is why one can search for “eu grants” and still not be linked to www.europa.eu in the first 1000 hits.
There is no way to control the publisher, anybody can publish anything today using various interne tools.
Information can seem contradicting to the layman with slim competence to evaluate the information and to prioritize between statements.

The logical/technological framework of GM, (In the description the abbreviation “GM” is used as a synonym to “the invention”) consisting of POS, MEAD & Sentensa can be used for many problems, similar to those of applying for grants. Basically, all tasks dependant of exact information, where there is an enormous surplus of information available.

The same principles are applied in the tasks described bellow as in solving the problems regarding grant applications. The GM provides a technology to peel away unnecessary information. The key functions is deciding what information to dispose of and how to peel the surplus away.

The first step is to focus only on a few themes of information (as described below), mostly on legal documents/issues and business related issues. The second step is to filter the publishers/writers and to dispose of those considered unserious. If one were to illustrate all information on the internet in a matrix with all publishers horizontally and all themes vertically, the GM selection process can be illustrated as the two circles created in the intersections presented in such a figure (see Fig. e):

After the mechanical selection described above, the information gets filtered and systemised. First, only information which actually describes the query a person is looking for is relevant for evaluation, not all information where the query is mentioned. If one is interested in information on “German VAT”, the POS searches for information on that subject with conceptual vectors, rather than all documents where the words may appear (which is the principle of search engines today). Hence only the most relevant documents appear, and the POS doesn't discriminate documents with “German value added tax” or “Germany VAT” or “DE VAT” or even “VAT NDR” (NDR being a German province).

The second step is to filter such information containing very poor writing, as such can be considered poor in quality as well as in writing. This process consists of an advanced spam-filter, where the filter is “trained” on a database with manually predefined documents. There are actually close to 1 000 000 pages in the databases. Hence, the filter learns the “style” in which correct documents are written, meaning the common way of expression. Most laypeople's writing will be identified rather quick due to such stylistic errors, as using to complex wording and descriptive redundancy. All information which is not stylistically adequate or placed in tables and templates would be eliminated.

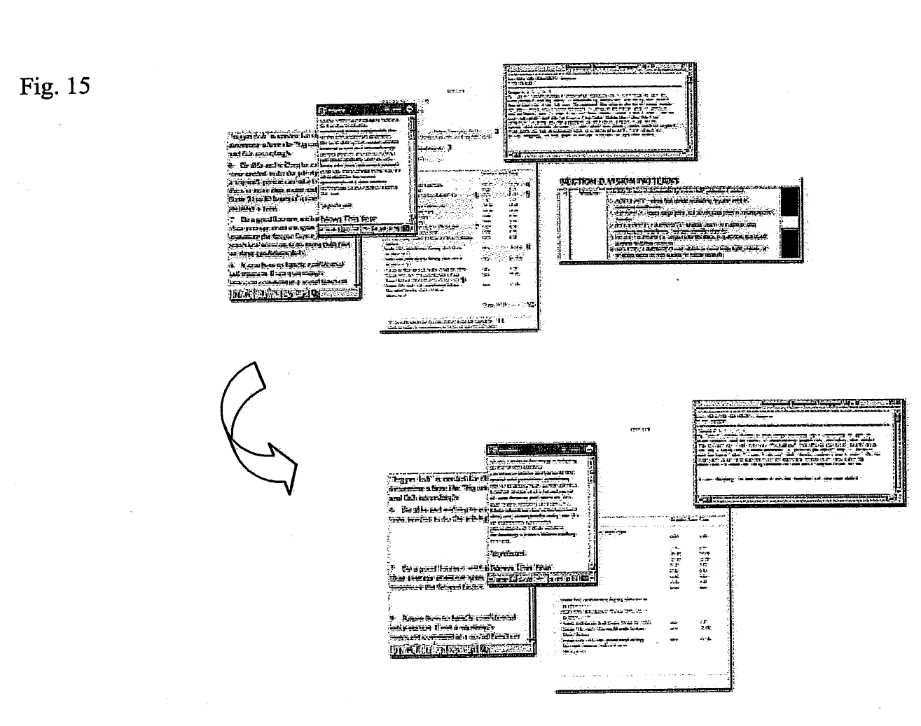

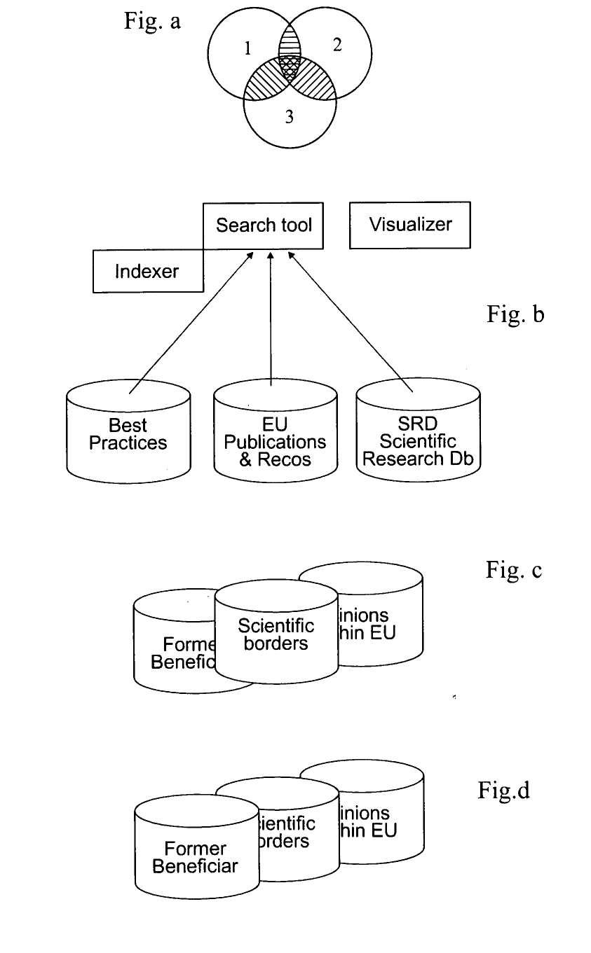

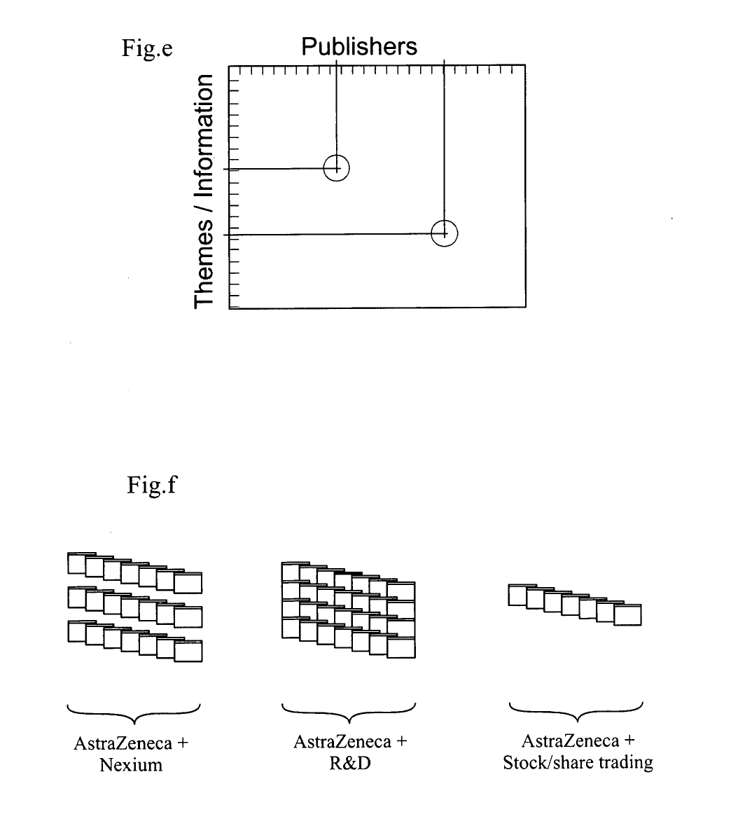

The third step is to filter for all information being presented once with the MEAD. Hence repetition is avoided and only previously unmentioned information is presented to the user. Assume that all the highlighted parts bellow has been presented already. The MEAD's main function is to block that information in the further presentation. In FIG. 15 there is presented an example of several documents, in part containing the same information, paraphrased or not (highlighted). The MEAD function eliminates the repetition of information, hence significantly shortening the documents.

In the same manner as writing grants—using the same principles—grant applications can be evaluated in a quick and efficient way. As well as evaluating single applications, many competing applications can be compared to each other. The evaluating person using GM can easily find “purpose”, “outcomes”, “outputs” or whatever he/she wishes from applications. If in doubt, other peer evaluators and colleagues can easily get an overview of an application and give second opinion.

The colleagues then don't have to read all the application, which often are several hundreds of pages. They are at a lesser risk of getting confused with technicalities irrelevant to the evaluation as such. All persons supervising the application can also run the proposed project against the database and look for similarities in already granted project, in that way avoiding to finance the same research twice. Hence, each evaluation will be conducted on the benefits and value of all proposed projects, rather than the linguistic abilities of the writers. The method will also save time and money. It allows for rational decision-making and diminish the risks of incorrect assumptions and decisions. Further, it will allow for a more coherent and concise evaluation within the organisation evaluating applications (i e the evaluators evaluations would be more similar and objective).

In a traditional text, there are commonly positive opinions as well as negative. The negative values may by negative words and expressions, which are predefined. To produce a word space (word spaces are the predefined values in a database containing valence (emotional value)) that contains predominantly syntagmatic relations, we built the distributional relations using entire documents as contexts (i.e. each dimension in the word space corresponds to a document in the data).

The main question, measuring the public opinion of an entity, one would use a database consisting of text from the internet (e.g. using Google or any other indexing search engine) and analyse them in the same principle as above. The achievements of such a conduct would be;
A large number of respondents, actually strictly correlating to the search results in an indexing search engine.
Ability to repeat the query at any time, as well as the ability of constant monitoring

When using the GM method, one can have a real-time system monitoring what is written about a person, company, product or market—and the way in which it is written (positive opinion or negative).

The benefits would be to capture the view of the public on a subject in real-time, and constantly updated. The number of respondents would by far be exceeding the respondents of traditional market research. It will be done so to a low cost and most importantly, the system will be totally objective since it does not interact with the respondent in any way.

The original use of GM can even be used to write a thesis, articles as well as reports; the writer of the text knows that there are certain rules to follow as well as customs and culture. In the same way as GM is used for general subsidy applications, it can also be used for other types of text regardless of quantity, amongst others reports etc. The issues and difficulties in writing an academic paper or thesis, are very similar to the difficulties of applying for grants. Hence, the GM can be used in a very similar way, sharing the same benefits of time effectiveness, high accuracy and low cost.

The method can even be used to make short concise company analyses (Due Diligence). The premier applications area is mainly to give a look on a company before deciding upon a partnership or supplying credit, purchases of the companies' products etc. In such cases the internet is used as a source of information. According to predefined parameters the irrelevant information is removed, as well as pages where the companies name is only mentioned one time, when the page is really about some thing else. Furthermore MEAD can automatically summarise many documents, so that each concept only shows up one time. The user thus will not have to read about the same thing on a thousand different pages. One search for “Astra Zeneca” will illustrate the following:

### (See Fig. f).

A figure may be used to present an overview of a search on AstraZeneca. In a first part it would present that “Nexium” is found in three clusters (by three publishing sources), each cluster defined by context vectors. In a second part it would present that the “R&D” search would return one cluster, although higher in frequency. In a third part it would present that “Stock trading” would also appears in one cluster, but smaller in frequency.

The software in this case understands that “Nexium” has been written many times, as well as by many different web sites and publishers. It has an higher worth then “R&D”, even if it has been described on more pages then “Nexium”, have done so on more contiguous web sites/publicists.

The MEAD-function interprets this as marketing³. Finally “Stock trading” is described on a minimum amount of web sites and thus receives less coverage. Mead-function summarises everything written about Nexium, so that each concept is mentioned once in a Due-diligence report. ³ The most probable scenario is that Astra writes about their product themselves, by the fact that the pages are considered as “near each other”, (www.astra.com/nexium1, nexium2, nexiumₙ

The benefits of using GM technology and method in Due-diligence are that it will provide the user with a updated view, combining internal as well of external information, removing all repetition of information, to a low cost. Today, such an overview will be costly and consume a lot of time—sometimes to such an extent that the information turns old. For that reasons, companies today always have to decide whether they should invest considerable effort an money, or if they shouldn't do a DD at all.

The patent searched method can even be used for writing business plans. In the same way GM is used for generalising subsidy applications, it can be used to generalise common or a niche business idea.

The user can define a business plan for a target group, whether it is going to be read by a bank or government agency, employees or partners or part owners or future investors. The user writes initially a business plan that transforms into different user groups, where the language, length, design, and content are adjusted to the reader.

In the same way as in subsidy applications, the GM starts with analysing the database known as “best practice”, which are manually analysed business plans. From there, GM constructs and suggests templates to the user, differing depending on the business niche and target group. Investors are interested more in transparency and full disclosure, where such information is mostly uninteresting for employees. Employees tend to appreciate things as visions, future, forecasts etc.

The GM will probably not make the writing of a business plan any cheaper, and it will not be done any faster. The benefits are on the recipients and readers of the plan, they will appreciate it more and (most) people that do not read such information may get decreased barrier to start doing so.

Already today there is a large library of “functions” for different programming languages (In front Java, PHP, Linux, Solaris plus many more.) the user can find different functions and incorporate them in to their software project. The weaknesses with this are that the user must know what he or she is looking for exactly.

With Mead in combination with Sentensa the user can make use of GM.s method to search with more freedom in the library without any larger demands placed upon them to know the exact name and definitions of the functions they are looking for. The first user group are probably developers of Open Source applications. There are several benefits of using GM, relative software construction today. The construction will be done to a decreased cost and time, but the major benefit is that using GM technology and the libraries described above, is that the code will be tried and tested and hence functional. Otherwise, bad code and bugs are the major problem for software developers and are responsible for both the time and cost.

Already today global companies manage more then 35 billion e-post messages and around a million documents (.pdf, .doc, .xls, .txt etc.). IBM⁴ has a prognosis that employees use more then 20% of their working time with just trying to find the right document. Further ahead large amounts of damage can occur if incorrect documents are shared out on the Internet (not updated, business secrets inside etc.) IBM are counting on that 85% of all digital information that is not stored logically in databases and in this case can be seen as inaccessible for the user, quite simply can not find the right file. ⁴ www.ibm.com/software

IDC⁵ publicised recently numbers that showed that it stored 36 times more information in 2006 then in 1998. These figures will rise in the future when even the governments store more and more information digitally. Sentensa-functions in GM can be used to find information and allow the user to look in his or her computer even if it does not know the size, format or user word in the document they are looking for. The user can ask Sentensa to search for “something that is about user interface or user friendly”, and so on. Such vague memory of something eventual text that can exist is common, the longer time has gone since the document that was last looked at, the memory is smaller. Sentensa found all of the documents that were about their concept, EVEN if the word that was used in the searched document was not 100% correct with what the user asked for Sentensa to look for. In addition advantages are obvious if Sentensa allows searching in the whole of the organisations network, to see if some one else has written about similar things. In this case the company can earn a lot of money from a lower amount of wasted time from the personal. The benefits of such a function increase the bigger an organisation is. The benefits become larger the more information is stored digitally. Finally the functions from Ω-(ts) incorporate (whistle) to Sentensa, which then can look after the concept and consistency in different languages. An employee from the EU or the UN can, in this case look at different areas in every language, for example “policy+environment”. ⁵ www.idc.com or http://www.idc.com/idcstore/store.jsp

The domain of public procurement, the GM software method works in the same manner as in writing grant applications. Best practices can be presented to the user, very specific examples showing the preferences of any certain authority or public organisation. A huge amount of information can be evaluated and accounted for by the user in the call for tenders.

In public procurement, it has been shown that formalities, expressions and semantics are really important in order to win a contract. That is, there are more factors than merely quality and price of the delivery. Those factors are abstract, unclear and informal. That is a similarity that public procurement has got in common with grants and funds. Hence, the success of both public procurement and grant applications are dependant on other factors than merely the factors that are stated in the call. Therefore, the GM can be applied on public procurement using the same principles as when applying for grants. The most important benefit of GM in this application is success rate, i e the GM helps the user to write a better offer. This is a really important feature since public contracts usually reach over significant time and are worth substantial amount of money. The GM helps in the most critical moment; when writing an offer.

The Law is a subject with an enormous amount of information available, where vast and considerable difficulties appear when trying to find facts or other information. The number of cross-references is so huge, the number is unknown. Lastly, the way in which different laws, paragraphs and prejudicial documents should be prioritized internally are the main headaches of legal courts. The difficulties for the professional are great, but the laypersons ability to educate themselves are next to none.

The GM technology gives the user some very improved possibilities to search those subjects by the same principles as for grant applications. The MEAD function eliminates repetition, and the POS and Syntensa functions improves the precisions in all queries. The user can then browse without initial specific knowledge of what they are searching for, the vector based context analysis enables the user to iterate and continuously improve the queries upon receiving the answers.

The difficulties of information retrieval- extraction- analysis- and systematization are universal to such an extent that the GM methodology can be applied on most subjects, domains and public libraries, as long as the information is digital. A public domain may be a library, physical or virtual. The benefit of using GM in those areas over the use of other available software's is that GM significantly improves usability, structure, information overview and the ability to find information. The user may not even have to know exactly what they are locking for, the just have to enter a sort description. The GM then convert this description to a context vector and compares it to other vectors in the database and then returns the matched documents to the user. The user may then highlight the document with showing the best match with what the user had in mind, and continue for an even more precise search, and continue the iteration until satisfying match are found.

The user can also use the method and technology in the process applying for patens and the protection on intellectual property. When writing the application for patents, one uses the same principle and technology as in the application for grants. Further uses in this area are browsing among current patent and protections in order to avoid misuse of protected rights and to identify pre-existing protection before and during the preparation and application. In total, the benefits are formulation of the patent application and search/research in the same application. The application can be used by patent applicants as well as evaluators in an authority. A person working in an organisation for registration of patents and intellectual property can use GM for a quick overview. The GM can then guide the user to the most probable cases where an intrusion is possible, thus saving much time and effort.

When doing journalistic work, on can use the GM method to make quick research and gather background information on the subject of interest. The principles are similar to the browsing of public domains, with addition that the search can be further refined and grouped according to predefined and/or personal settings. Further, one can make more use of the MEAD functionality to “write” new and current/updated articles which will then be produced automatically by a computer and updated at frequent intervals, or as soon as a search engine finds new/additional material. A newspaper/newsletter can then be automatically published with constant updated information in real-time.

As in the writing of real-time updated articles, the user can preset the searches to monitor one's competitors, one's market & users and competitors development of new products or services. The presets are simply tuned on the name of the competitors or specifications on the market. Even more, one cold apply the Sentensa functionality to identify possible competitors which are not known as of yet. The Sentensa will actually “sense” if new entities or products has similar market, similar use or business model.

A person can use GM to monitor any subject of interest, fashion, furniture or celebrities to name just a few examples. The benefits of using GM are that the method enables the user to monitor a large amount of information sources automatically. The GM filters all things which are of no interest to the user, hence saving even more time.

A information source, a newspaper for instance (or a webpage or any other source containing large amount of text) can adapt GM on their webpage to let each visitor tune the settings of interest. The settings would then be saved in cookies in the visitors computer for future remembrance. In contrast to the method used above, in this configuration the source are the suppliers of GM and enables all visitors to the functionality. The computing power of the visitors hardware will hence not be put to any strain.

The GM is very suitable in the writing of a variety of corporate reports, aimed at the public, as well as for internal use. The GM is then used for correct referencing, effective summarization, and controlling facts and figures. The user can even check for unnecessary repetition and to evaluate the readability and to use the context vectors to make sure the information is not contradictive or hard to understand. The recipient of such information, whether public or internal, can use the GM to retrieve only the information of interest. Hence recipients will not be bothered with unnecessary amount of information, both costly in time, and risking the avoidance of reading anything at all.

Even a single private person can use the GM to apply for personal scholarships, grants other personal financial support/aid for a specific purpose or in general. The principles are the same as for organisations applying for grants. The GM's core methodology of using vectors to describe content and context are universal and independent of language. If using a corpus of satisfactory size, the vectors will be proximate regarding of the language in use. Hence a query can be researched, evaluated and monitored without translating documents to English, which will increase the amount of information significantly. The user can receive documents in French for instance, with a simple translated summary done in Ωₜₛ which can give a sufficient understanding for the user to evaluate whether they should proceed for a manmade state-of-the-art translation or not.

The GM can be used to evaluate texts in order to control for copying, theft, and forbidden paraphrasing and rewriting. The GM will compare the context vectors of the submitted text to all texts in a database and evaluate for suspicious proximities and similarities. When comparing vectors, the controller can identify even totally rewritten or paraphrased text and hence catch a cheater, thief or anybody who has incorrectly submitted a text and untruthfully claimed it for his own. Such controls are only limited to the size and content of the database which the controller uses, and are not limited to language uses. Hence, even translated theft can be controlled

The controls can be done automatically by the GM software, which will report and present only suspicious similarities to the controller for manual evaluation.

The GM can use the same vector parameters in controlling theft in the software industry, in identifying suspicious similarities in software architecture, source code or in the commented sections besides the code. When using GM, the precision can be manually tuned by the controller be processed automatically and quickly. The benefits of using GM to current methods are that theft can not be “hidden” by adding personal code and use the illicit code in seemingly random order. Such random tactics of theft will be identified by the GM algorithms.

The GM is very suitable for a layperson in the writing of legal agreements and documents. Using the same methods as when applying for grants, the user will get examples of existing documents from a database and be able to modify such documents according to the specifics of the case in question. If a person for instance is writing an agreement for cooperation with other corporations, the GM will present templates and examples for cooperation agreement in general. If the cooperation is regarding transportation issues for example, the GM will further specify the templates with specifics on transportation issues, but only relevant to cooperating agreements. The GM does such operations by comparing vector proximity of agreement issues with those of transportation, thus eliminating all templates from transportation in general because it lacks proximity to the former. The functions are most valuable for laymen writing general agreements and for professionals when writing multinational agreements with many parties, all following different national laws. An illustration is a ship build in Australia, by a Swedish company and sold to an Italian company registered in Greece. The ship is being run by a Japanese crew, transporting Chinese merchandise. The ship has a Swiss insurance, the merchandise a Canadian and the crew are insured by an American company. If the ship sinks on Russian water, who is to blame and who is to pay? Using GM will be helpful in avoiding legal meltdown. The usage described above related to “The Law” is primarily/mostly useful for legal professionals interpreting law in complex question, which differentiate it from the use described in this paragraph. The usage described above related to “a layperson” is primarily aim at people with a need in the legal sectors, mainly to construct some sort of document. Most probably, such people do not have the time or interest to penetrate legal questions in-depth, they want to construct the document “good enough”. Hence this usage is focused at a slightly different use of the GM technology, using tweaked algorithms and GUI.

Since the vectorized SOM can value and distinguish between concepts, meaning, web pages and documents (mathematically close to “understanding”), we can use the methodology to generate texts, while keeping the meaning and context of the text. The reference points for this are occurring texts on the web. A concept, for instance insurances are defined by its context-vector, describing the concepts normal semantic/linguistic use. Instead of using databases as in the original patent, we use a web crawler (also known as digger or scraper) simplified it is an indexing search engine which finds texts on the web and saves the texts to a new database. In order to find web pages, any indexing search engine can be used with the search for the concept (insurance in the example). All texts which are scraped from the 1000 first results for instance, are then vectorized a compared to one another. If a majority of the documents defines insurances as important and/or expensive and/or complicated these words will be regarded as “true”, and the true words will be regarded as labels (l₁, l₂, −lₙ) defining the term insurance. We now have a term, insurance possessing the characteristics l₁, l₂, −lₙ. In the next step, the crawler searches for the results of a term with context proximity to insurance which is automatically or manually selected, for instance the term pension. The same evaluation of characteristics is done with the new term, defining characteristics/labels from the majority of the first 1000 search results, defining them as “new labels” (nl₁, nl₂, −nlₙ). Those new labels are considered to be true for the term pension. In the third step, all of the synonyms of each label is identified for both terms and labelled as 1−n[lₙ] meaning the first to the n:th synonym of all the labels from l₁−lₙ for insurance and likewise 1−n[nlₙ] for all combinations of labels and label synonyms for pension. All the label combinations for pension are then negated, meaning that the opposite of the labels are formed. This is done automatically by a corpus engine, for example the open source software/corpus/directory Wordnet. The following step compares labels between the terms insurance and pension and the first labels are given dominance (the label/synonym matrix regarding insurance) meaning that when any label/synonym defining insurance 1−n[lₙ] is in contrast to any label/synonym defining pension, 1−n[nlₙ], the latter 1−n[nlₙ] is eliminated (via the use of it's negative)

For example, insurances may be labelled as “expensive”, and pensions may be defined as “cheap”, then first “cheap” is negated to it's opposite which is “expensive”, and hence 1[lₙ] will be equal to 1[nlₙ] and eliminate the latter (i e “expensive” is equal to “n(expensive)”).

The negation of the new labels defining pension are necessary for computational reasons. It is thus more efficient to compare a label to an already negated new label, rather than simultaneously compare the label with the new label and then decide if they are conflicting. This would put to much strain on the CPU and RAM.

The result of all operations above are three sets of information;
1. Labels defining insurance,
2. Remaining labels defining pension, no contradictive relative insurance,
3. Semantically correct phrases with low/no meaning, filtered from words only found pension definitions.

We now insert insurance instead of pension in the pension-text (number 3 above) and insert label or synonym 1−n[lₙ] where appropriate (number 1 above). The appropriateness regarding labelling is defined by the indexed vector-space of the remaining texts (number 3 above), whilst the SOM has been trained on large texts from archives/directories (for instance all the articles from the newspapers Times and Observer year 1990-2005).

For instance, if the phrases of text (number 3 above) states “The main responsibility for the growth of ______ scams are laid on the government by the media”, and the blank space ______ defines that the word “pension” is removed and that “government” is the label, this proposed technology would insert the word “insurance” in the blank space, and exchange “government” to an appropriate label (which may be “corporation” or “average Joe” or “foreigners” depending on the co-existence of the keywords “insurance, scam, growth, responsibility, media” and the respective label (“corporation” or “average Joe” or “foreigners”).

In reality, if there are scams in the area of insurances, our technology will identify and write who is blamed by the media, if the media are blaming someone, of course.

The main point of all described above regarding “the latter usage” is that the software can generate consistent texts which are semantically and linguistically correct, the facts and statements will be accurate, and the text will be composed of paragraphs, sentences and phrases which are unique in the area of insurances. Publishing 10 000 pages with such text (approx. 5 million words) will make any search engine (Google etc.) to present the webpage as the most significant search result. There will be no way for the search engines to identify that the texts are artificially generated since the texts are based on manually written text (borrowed from pensions). Such a text generator would be very valuable, since SEO is growing exponentially.

The invention is not limited by what has been described above but may be varied within the scope of the pending claims. For instance, it is evident that to the skilled person within the field the term server has to be construed in a broad manner and that its functionality may be achieved in many different manners, e.g. by having a distributed net work of servers that are interconnected, etc., etc. Moreover it is evident for the skilled person that a variety of different sets of software components may be used to achieve the main purpose of the invention, i.e. sets of software components that include fewer or more than those shown in the preferred example, but including the basic components of a system of the invention as defined in claim 1. Moreover the applicant foresees that different aspects described in the specification, which are not directly covered by claim 1, may be the subject for one or more divisional applications, e.g. the method described relating to optimization of searches, and indeed also sub components/sub functions described above.

1. (canceled)

2. A system for assisting in drafting applications, said system comprising:
a server having a processing device;
a memory device either directly or indirectly connected to said server; and
software installed on said server, wherein said memory device includes information regarding requirements to be met by said applications and said software is arranged to assist in retrieving relevant information and actively assisting in drafting said applications to meet certain requirements, and wherein said memory device contains linguistic information based on data from at least successfully prosecuted applications and that said software is arranged to assist in choosing a linguistic approach based on said linguistic information.
